(19) United States
(12) Patent Application Publication
(10) Pub. No.: US 2017/0277722 A1
(43) Pub. Date: Sep. 28, 2017

(54) SEARCH SERVICE PROVIDING APPARATUS, SYSTEM, METHOD, AND COMPUTER PROGRAM

(71) Applicant: NAVER Corporation, Seongnam-si, Gyeonggi-do (KR)

(72) Inventors: Hye Eun NOH, Seongnam-si (KR); Hyo Jung KIM, Seongnam-si (KR)

(73) Assignee: NAVER Corporation, Seongnam-si, Gyeonggi-do (KR)

(21) Appl. No.: 15/508,946

(22) PCT Filed: Aug. 26, 2015
(86) PCT No.: PCT/KR2015/008938

§ 371 Date: Mar. 6, 2017

(30) Foreign Application Priority Data
Sep. 5, 2014 (KR) 10-2014-0119385

(51) Int. Cl. G06F 17/30

(52) U.S. Cl. CPC G06F 17/30277; G06F 17/30867; G06F 17/30398; G06F 17/30253

(57) ABSTRACT

Provided is a search service providing apparatus including: an input data type display unit configured to display a plurality of selectable input data types; a search target data input controller configured to control search target data corresponding to each of the plurality of input data types to be received; a search area input unit configured to control a search area including an object to be searched for to be received within the search target data; a search area analyzer configured to detect at least one object included in the search area by analyzing the search area, and extract at least one feature of the at least one object as a parameter; a search query generator configured to generate a search query comprising the at least one object and the parameter; and a search query transmitter configured to transmit the search query to a service server.

### CROSS-REFERENCE TO RELATED APPLICATIONS

This application is a U.S. national phase application under 35 U.S.C. §371 of PCT International Application No. PCT/KR2015/008938 which has an International filing date of Aug. 26, 2015, which claims priority to Korean Patent Application No. 10-2014-0119385 filed on Sep. 5, 2014, the contents of both of which are hereby incorporated by reference in their entireties.

### TECHNICAL FIELD

The present disclosure relates to a search service providing apparatus, system, method, and a non-transitory computer readable medium storing a computer program, and more particularly, to a search service providing apparatus, system, method, and computer program, which receive data through a plurality of input methods and provide a search result from the data.

### BACKGROUND

A computing environment is gradually developing for user convenience. The user may process, collect, and/or use information through a computing device (for example, a computer). In particular, the user may search for various types of information on the Internet through his/her computer.

The user may use one or more input devices (for example, a keyboard or a mouse) while using the computing device (for example, a computer). Here, the user may have to perform an operation by using different input devices according to characteristics or types of the operation.

For example, when the user is searching for certain information on the Internet, according to a general method, a process of loading a certain search tool or accessing a website of a service provider providing a search service needs to be performed first before the user performs a search. Such a process is performed by using a mouse or a corresponding device (for example, a touch pad) in a recent computing system in which most operating systems (OSs) employ a graphical user interface (GUI) environment.

After accessing the search tool and/or a search website, the user performs a process of inputting information to be searched for to a certain location (for example, a text box). At this time, a keyboard or a corresponding device capable of inputting text and/or a character may be mostly used.

### SUMMARY

Provided are a search service providing apparatus, system, method, and a non-transitory computer readable medium storing a computer-executable computer program, wherein different types of search target data are received and analyzed to provide a search result corresponding to the search target data, thereby enabling information about a target to be searched for to be input in various forms without being limited to text and searched for.

Provided are a search service providing apparatus, system, method, and a non-transitory computer readable medium storing a computer-executable computer program, wherein information to be searched for by a user is actively provided by providing a search result considering a type of a target to be searched for.

According to an aspect of an embodiment, a search service providing apparatus includes: an input data type display unit configured to display a plurality of selectable input data types; a search target data input controller configured to control search target data corresponding to each of the plurality of input data types to be received; a search area input unit configured to control a search area comprising an object to be searched for to be received within the search target data; a search area analyzer configured to detect at least one object included in the search area by analyzing the search area, and extract at least one feature of the at least one object as a parameter; a search query generator configured to generate a search query including the at least one object and the parameter; and a search query transmitter configured to transmit the search query to a service server.

The search service providing apparatus may further include a search result receiver configured to receive a search result corresponding to the search query from the service server.

The search target data input controller may be further configured to: when an input data type is an image, receive a real-time image input through an imaging unit as data or receive one of pre-stored image files as data, and when an input data type is voice, receive sound data input through a sound input unit as data or receive one of pre-stored voice files as data.

The search area analyzer may be further configured to, when data included in the search area is voice data, convert the data to text and extract the text as the parameter.

The search result receiver may be further configured to, when the object to be searched for is a person, receive information about a person including the parameter as the search result.

The search result receiver may be further configured to, when the object to be searched for is a garment, receive information about a person who made the object or information about the garment comprising the parameter as the search result.

According to an aspect of another embodiment, a service server includes: a search query receiver configured to receive a search query including at least one piece of data from a search service providing apparatus; a query analyzer configured to detect at least one object included in the at least one piece of data, and extract a feature of the at least one object as a parameter; and a search result provider configured to transmit a search result matching the at least one object and the parameter, to the search service providing apparatus.

The query analyzer may be further configured to, when the at least one piece of data comprised in the search query is an image type or a video type, detect the at least one object included in the at least one piece of data by analyzing the at least one piece of data according to a pre-stored algorithm, and extract the feature of the at least one object as the parameter.

The query analyzer may be further configured to, when the at least one piece of data comprised in the search query is a voice type, convert the at least one piece of data to text, and extract the text as the parameter.

The search result provider may be further configured to, when the at least one object included in the at least one piece of data is a person, search for information about the person including the parameter, and transmit found information to the search service providing apparatus.

The search result provider may be further configured to, when the at least one object included in the at least one piece of data is a garment, search for information about a person who made the garment including the parameter or information about the garment including the parameter, and transmit found information to the search service providing apparatus.

According to an aspect of another embodiment, a search service providing system includes: a search service providing apparatus; and a service server, wherein the search service providing apparatus includes: an input data type display unit configured to display a plurality of selectable input data types; a search target data input controller configured to control search target data corresponding to each of the plurality of input data types to be received; a search area input unit configured to control a search area comprising an object to be searched for to be received within the search target data; a search area analyzer configured to detect at least one object included in the search area by analyzing the search area, and extract at least one feature of the at least one object as a parameter; a search query generator configured to generate a search query comprising the at least one object and the parameter; and a search query transmitter configured to transmit the search query to the service server.

According to an aspect of another embodiment, a search service providing method includes: displaying a plurality of selectable input data types; controlling search target data corresponding to each of the plurality of input data types to be received; controlling a search area comprising an object to be searched for to be received within the search target data; detecting at least one object included in the search area by analyzing the search area, and extracting at least one feature of the at least one object as a parameter; generating a search query including the at least one object and the parameter; and transmitting the search query to the service server.

The search service providing method may further include receiving a search result corresponding to the search query from the service server.

The controlling of the search target data may include: when an input data type is an image, receiving a real-time image input through an imaging unit as data or receiving one of pre-stored image files as data, and when an input data type is voice, receiving sound data input through a sound input unit as data or receiving one of pre-stored voice files as data.

The converting and analyzing may include, when data included in the search area is voice data, converting the data to text and extracting the text as the parameter.

The receiving of the search result may include, when the object to be searched for is a person, receiving information about a person comprising the parameter as the search result.

The receiving of the search result may include, when the object to be searched for is a garment, receiving information about a person who made the object or information about the garment comprising the parameter as the search result.

According to an aspect of another embodiment, a computer program is stored in a non-transitory computer readable medium to execute the above method by using a computer.

According to an aspect of another embodiment, there are further provided another method, another system, and a non-transitory computer-readable recording medium having recorded thereon a computer program for executing the other method.

Additional aspects will be set forth in part in the description which follows and, in part, will be apparent from the description, or may be learned by practice of the presented exemplary embodiments.

A search service providing apparatus, system, method, and a non-transitory computer readable medium storing a computer-executable computer program according to one or more embodiments of the present disclosure may receive and analyze different types of search target data to provide a search result corresponding to the search target data, thereby enabling information about a target to be searched for to be input in various forms without being limited to text and searched for.

Also, a search service providing apparatus, system, method, and a non-transitory computer readable medium storing a computer-executable computer program according to one or more embodiments of the present disclosure may actively provide information to be searched for by a user by providing a search result considering a type of a target to be searched for.

### DESCRIPTION OF THE DRAWINGS

FIG. 1 is a diagram of a search service providing system according to an embodiment of the present disclosure.

FIG. 2 is a detailed diagram of a search service providing system according to an embodiment of the present disclosure.

FIGS. 3 and 4(a)-4(c) are diagrams illustrating screen layouts of a search service providing apparatus of FIG. 2.

FIGS. 5(a) and 5(b), 6(a) and 6(b), and 7(a) and 7(b) are diagrams illustrating screen layouts of the search service providing apparatus of FIG. 1.

FIG. 8 is a diagram of a search service providing system according to another embodiment of the present disclosure.

FIG. 9 is a flowchart of a search service providing method according to an embodiment of the present disclosure.

FIG. 10 is a flowchart of a search service providing method according to an embodiment of the present disclosure.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects.

In drawings, like reference numerals refer to like elements throughout and overlapping descriptions shall not be repeated.

It will be understood that although the terms “first”, “second”, etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprise” or “include” used herein specify the presence of stated features or components, but do not preclude the presence or addition of one or more other features or components.

When a certain embodiment may be implemented differently, a specific process order may be performed differently from the described order. For example, two consecutively described processes may be performed substantially at the same time or performed in an order opposite to the described order.

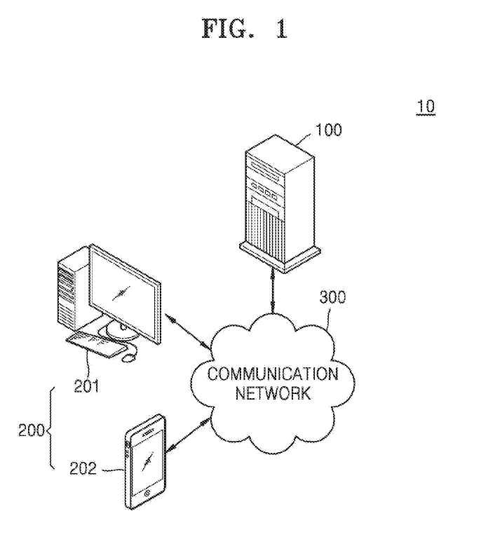

FIG. 1 is a diagram of a search service providing system 10 according to an embodiment of the present disclosure. Referring to FIG. 1, the search service providing system 10 according to an embodiment of the present disclosure may include a search service providing apparatus 200, a service server 100, and a communication network 300.

The search service providing apparatus 200 may receive search target data corresponding to each input data type according to a plurality of input data types selected by a user, and assign a search area including an object to be searched for by the user within the search target data. Also, the search service providing apparatus 200 may analyze the search area according to a pre-stored algorithm to extract at least one object and at least one parameter, which are to be included in a search request. In detail, the search service providing apparatus 200 may detect at least one object included in the search area, and extract a feature of the at least one object as the parameter. Meanwhile, the search service providing apparatus 200 may generate a search query including the object and the parameter, and transmit the search query to the service server 100 outside the search service providing apparatus 200 to request for a search. Here, the search service providing apparatus 200 may request for a search on an object, such as a thing, an animal, a plant or a person, included not only in text, but also in any one of various types of data, such as an image and sound.

Here, an object denotes a target to be searched for in a search area, has a concept including an animal, a plant, a thing, a product, or a person, and includes a proper noun or a common noun, which is invisible. A parameter denotes a feature of an object, may specify or limit the object or may be searched for with the object, and includes any information inputtable when the object is searched for.

According to another embodiment, the search service providing apparatus 200 may receive search target data corresponding to each input data type according to a plurality of input data types selected by the user, assign a search area to be searched for within the search target data, and then generate and transmit a search query including the search area to an external service server. According to such embodiments, the service server 100 may be requested to perform a search without a process of analyzing a search area.

Here, the search service providing apparatus 200 may correspond to at least one processor or may include at least one processor. In this regard, the search service providing apparatus 200 may be driven by being included in another hardware device, such as a microprocessor or a general-purpose computer system. For example, the search service providing apparatus 200 may be mounted in a terminal including a display unit for displaying a screen.

The service server 100 may transmit a search result corresponding to the search query received from the search service providing apparatus 200, to the search service providing apparatus. Here, the search result may vary according to a type of the object included in the search query.

According to another embodiment, the service server 100 may analyze the search query received from the search service providing apparatus 200 to extract the object to be searched for and the parameter that is the feature of the object. Also, the service server 100 may search for a search result corresponding to the object to be searched for and the parameter of the object, and transmit the search result of the search service providing apparatus.

Meanwhile, the communication network 300 connects the service server 100 and the one or more search service providing apparatus 200. In other words, the communication network 300 is a communication network providing an access path such that the search service providing apparatus 200 exchanges data with the service server 100 after accessing the service server 100.

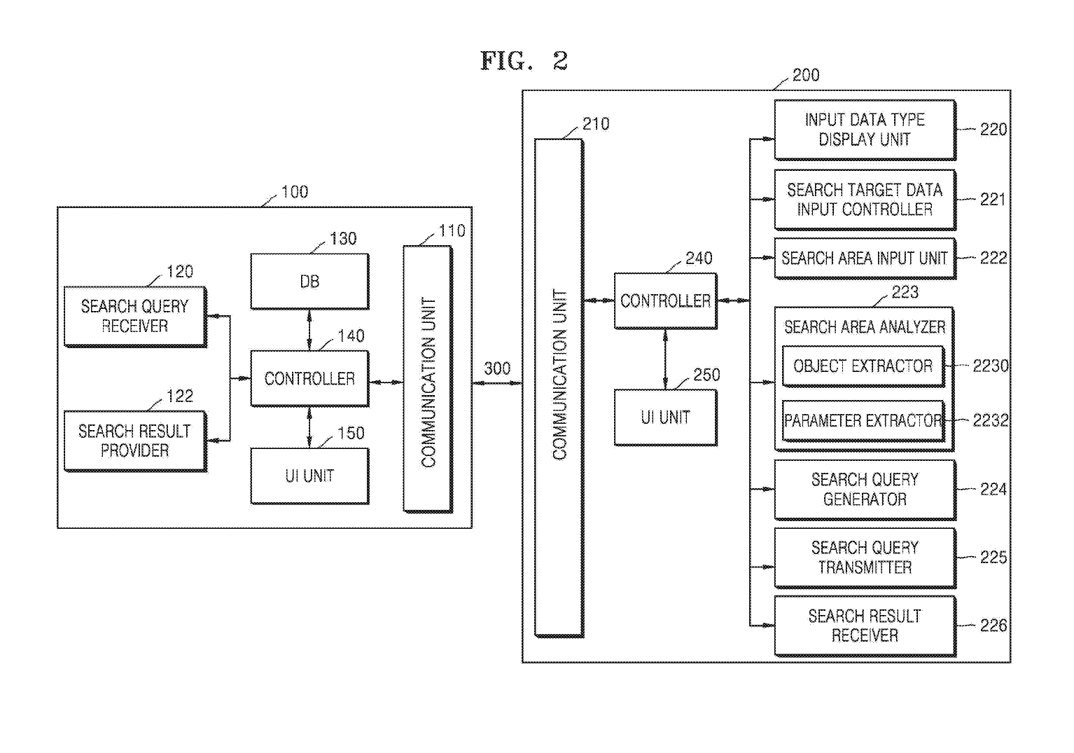

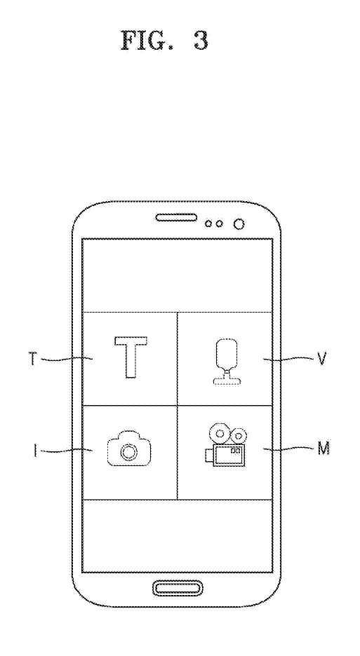

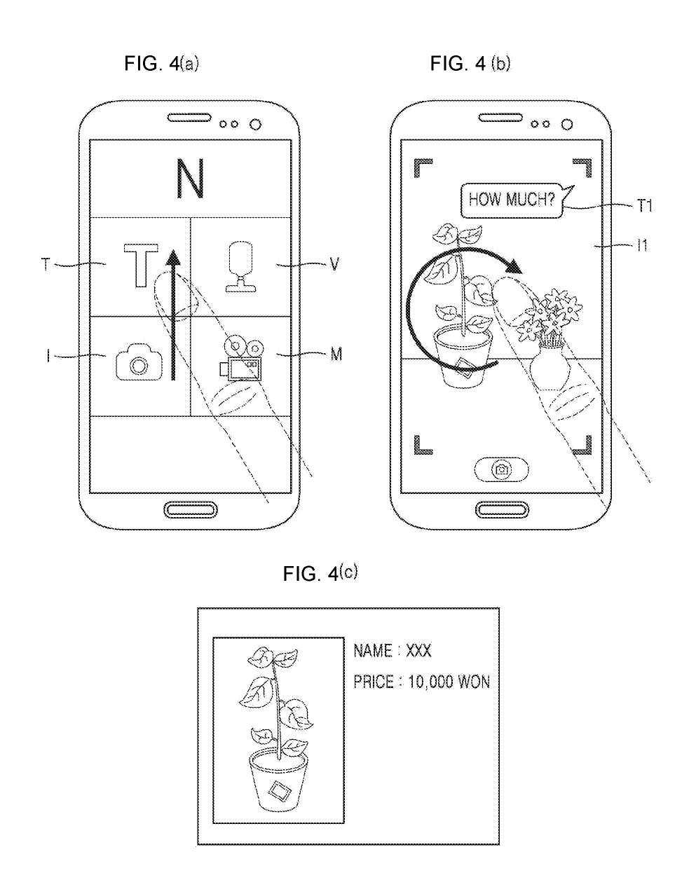

FIG. 2 is a detailed diagram of a search service providing system according to an embodiment of the present disclosure, and FIGS. 3 and 4 are diagrams illustrating screen layouts of a search service providing apparatus of FIG. 2. Here, FIG. 2 illustrates only components of the search service providing apparatus 200 related to the current embodiment in order to prevent features of the current embodiment from being blurred. Accordingly, it would be obvious to one of ordinary skill in the art that general-purpose components other than those shown in FIG. 2 may be further included.

Referring to FIGS. 2 through 4(a)-4(c), the service server 100 according to an embodiment of the present disclosure may include a communication unit 110, a database (DB) 130, a controller 140, a user interface (UI) unit 150, a search query receiver 120, and a search result provider 122.

The communication unit 110 connects the service server 100 to the search service providing apparatus 200 through a communication network, and performs a data exchanging function therebetween.

The UI unit 150 receives an input signal from a user and at the same time, outputs an output signal to the user, and may include a keyboard, a mouse, a monitor, an imaging unit, and a sound input unit. Also, the UI unit 150 may be a touch screen of a tablet personal computer (PC).

The controller 140 displays a screen on the UI unit 150 of the service server 100, and receives various commands or operations from the user through the screen.

The search query receiver 120 may receive a search query including at least one piece of data from a terminal. Here, the at least one piece of data may be at least one type of text, an image, a video, and voice.

The search result provider 122 may transmit, to a user terminal (the search service providing apparatus), a search result corresponding to an object and a parameter included in the search query. As will be described later, the search result may be variously provided according to a type of the object included in the search query.

Hereinafter, the search providing apparatus 200 according to an embodiment of the present disclosure will be described in detail.

Referring back to FIGS. 2 and 3, the search service providing apparatus 200 according to an embodiment of the present disclosure may include a communication unit 210, an input data type display unit 220, a search target data input controller 221, a search area input unit 222, a search area analyzer 223, a search query generator 224, a search query transmitter 225, a search result receiver 226, a controller 240, and a UI unit 250.

The communication unit 210 connects the search service providing apparatus 200 to the external server 100 through a communication network, and performs a data exchanging function therebetween.

The UI unit 250 receives an input signal from a user and at the same time, outputs an output signal to the user, and may include a keyboard, a mouse, a monitor, an imaging unit, and a sound input unit. Also, the UI unit 150 may be a touch screen of a tablet PC.

The controller 240 displays a screen on the UI unit 250 of the search service providing apparatus 200, and receives various commands or operations from the user through the screen.

The input data type display unit 220 displays a plurality of selectable input data types such that the user may select a plurality of input data types. For example, the input data type display unit 220 may display, on the search service providing apparatus 200, at least two input data types from among text, an image, voice, and a video, such that the user may select at least two of the at least two input data types.

For example, the input data type display unit 220 may form a screen of a user terminal such that at least two input data types are selectable from among text T, an image I, voice V, and a video M, as shown in FIG. 3. For example, selection regions for selecting the text T, the image I, the voice V, and the video M may be displayed by suitably splitting the screen. The input data type may be selected via a user's touch, but selection of an input method is not limited thereto.

Here, the search service providing apparatus 200 according to an embodiment of the present disclosure enables at least two input data types to be selected from among the plurality of input data types displayed by the input data type display unit 220, and enables search target data corresponding to each of the at least two input data types to be input.

In other words, as shown in FIG. 4 (a), the user may select the text T and the image I from among the text T, the image I, the voice V, and the video M displayed in the search service providing apparatus 200. Here, a method of selecting a plurality of input data types may be performed via touch-and-drag as shown in FIG. 4 (a), or alternatively, may be performed via any one of various manners, such as long tap-and-touch, and simultaneous touch.

Meanwhile, when the plurality of input data types are selected through the input data type display unit 220, the search target data input controller 221 may control related hardware such that the search target data corresponding to each of the selected input data types is received. For example, when the input data type is an image or a video, the search target data input controller 221 may enable an imaging unit (not shown) to receive an image by supplying power to the imaging unit, or when the input data type is voice, the search target data input controller 221 may enable a sound input unit (not shown) to receive sound data by supplying power to the sound input unit.

Here, the search target data input controller 221 may control data to be received according to one or more input units input through the input data type display unit 220. In other words, when a plurality of input methods of the user are a first input method and a second input method, the search target data input controller 221 may control first data according to the first input method and second data according to the second input method to be input.

In other words, when a selected input data type is text, input data may be text, and when a selected input data type is an image, input data may be an image file. Meanwhile, when a selected input data type is a video, input data may be a video file, and when a selected input data type is voice, input data may be a voice file.

The search target data input controller 221 may receive at least one piece of data according to the selected input data types, and at this time, the at least one piece of data may be input differently. For example, when the selected input data type is text, the search service providing apparatus 200 according to an embodiment of the present disclosure may receive input data by displaying an input region to which an input may be performed by using a keyboard or a touch pen. Meanwhile, when the selected input data type is an image, one of the stored image files may be received as data or image data displayed on an imaging unit (not shown) included in the apparatus may be received as data. Meanwhile, when the selected input data type is a video, one of the stored video files may be received as data or video data displayed on an imaging unit (not shown) included in the apparatus may be received as data. Meanwhile, when an input method is voice, one of the stored voice files may be received as data or sound data input through a sound input unit (not shown) included in the apparatus may be received as data.

The search target data input controller 221 may vary screen layouts shown to the user according to input methods. When an input method is text, a keyboard screen for inputting text may be displayed, and when an input method is an image or a video, a real-time image may be displayed on an imaging unit (not shown) or a stored image or video list may be displayed. When an input method is voice, a screen for receiving sound data through a sound input unit (not shown) may be displayed or a stored voice file list may be displayed.

Here, the search target data input controller 221 may receive search target data corresponding to each of the plurality of input data types. For example, when the user selects two or more input data types from among the plurality of input data types as shown in FIG. 4 (a), the search target data input controller 221 may receive, as image data, an image captured through the imaging unit of the search service providing apparatus 200 and at the same time, receive text data through a text input window displayed together on the image, with respect to the image and the text that are the selected input data types, as shown in FIG. 4 (b). In other words, as shown in FIG. 4(b), the image captured through the imaging unit and the text of “how much?” input through the text input unit are each input as the search target data. Also, a search is performed on the search target data, and a search result may be provided as shown in FIG. 4 (c).

When an input method input from the user is the first input method and/or the second input method, the search target data input controller 221 may sequentially receive the first input data according to the first input method and the second input data according to the second input method.

The search area input unit 222 may control a search area including an object to be searched for to be received within data, from the user. When two pieces of data, i.e., the first input data and the second input data, are received from the user, some or all of the first input data may be received as a first search area and some or all of the second input data may be received as a second search area, from the user. A method of receiving a search region from the user by the search area input unit 222 may vary according to a type of input data. The search area input unit 222 may assign at least one search area within the first input data input from the user.

For example, as shown in FIG. 4 (b), when a type of input data is an image, a search area may be assigned by touching a certain area on the image while the image is displayed. Alternatively, when a type of input data is voice or a video, a search area may be assigned by selecting a start point and an end point of the search area from a voice file or a video file.

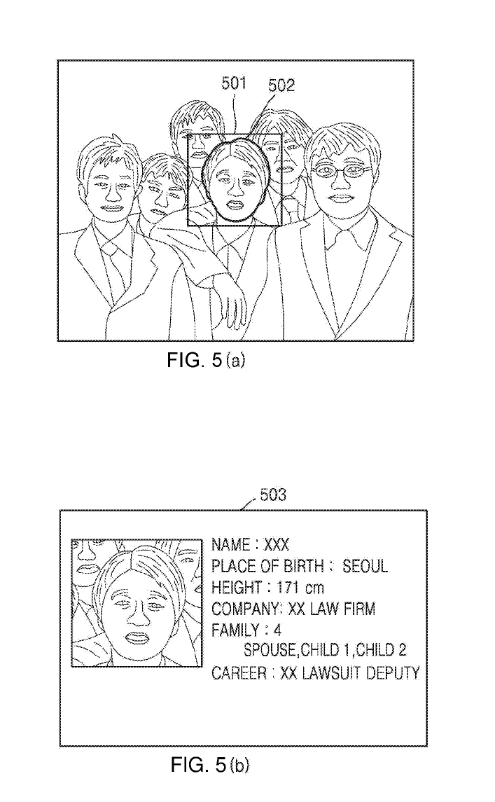

The search area analyzer 223 may analyze the search area via a method classified according to a type of the data to detect at least one object included in the search area and extract at least one feature of the at least one object as a parameter. For example, when the user assigned a first search area and a second search area, at least one object included in the first and second search areas may be detected by using an analyzing algorithm according to a type of each data, and a feature of the at least one object may be extracted as a parameter. For example, as shown in FIGS. 5(a)-(5b), when input data is an image file, the user may assign a partial area 501 of the image file as a search area. Here, when an object 502 is found in the search area 501, a feature of the object 502 included in the search area 501 may be extracted as a parameter, by using a technique for extracting a feature from an image.

Here, the search area analyzer 223 may further include an object extractor 2230 and a parameter extractor 2232.

In detail, the object extractor 2230 may extract at least one object included in input data. The object extractor 2230 may extract at least one object included in a search area of the input data. A method of detecting an object from an image or video file may be a color-based method, an area-based method, an active contour-based method, or a feature-based method, but is not limited thereto. Since such methods are well known, details thereof are not provided herein.

The parameter extractor 2232 may extract a feature of an object as a parameter. The parameter extractor 2232 may extract a feature point included in the object as the parameter. Here, the feature point is a point for easily identifying an object even when a shape, size, or location of the object is changed, and is a point easily found from an image even when a point of view or illumination of a camera is changed. Generally, a feature point that satisfactorily shows a feature of an object is a corner point, and such a corner point may be extracted through a well-known algorithm for extracting a feature point. Since the corner point is well-known technology, details thereof are not provided herein.

For example, as shown in FIGS. 5(a) and 5(b), when the user assigned the area 501 as a search area from among the entire screen, the object 502 included in the search area 501 may be detected as an object, and a feature point of the object 502 may be extracted as a parameter. Also, search information 503 of the object 502 may be provided based on the parameter.

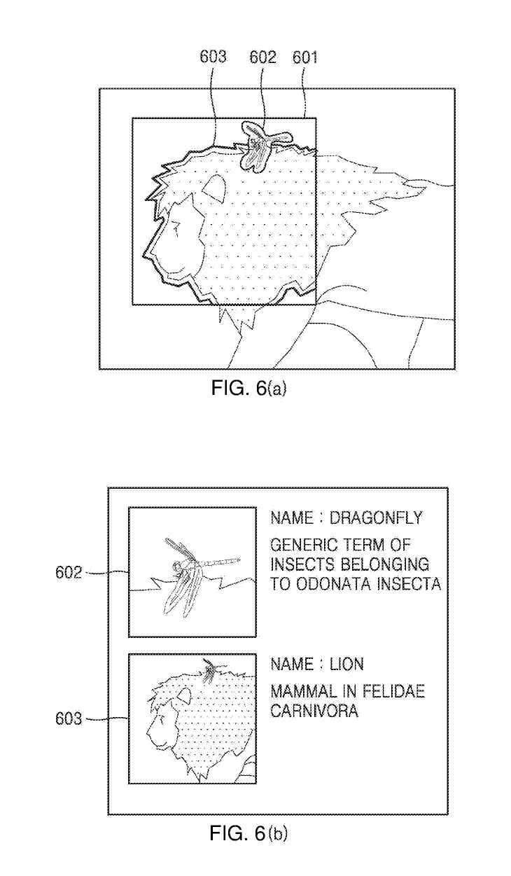

Alternatively, as shown in FIGS. 6(a) and 6(b), when the user assigned an area 601 as a search area from among the entire screen, objects 602 and 603 included in the search area 601 may be detected, and feature points of the objects 602 and 603 may be extracted as parameters. Then, search information about the objects 602 and 603 may be provided by using the parameters.

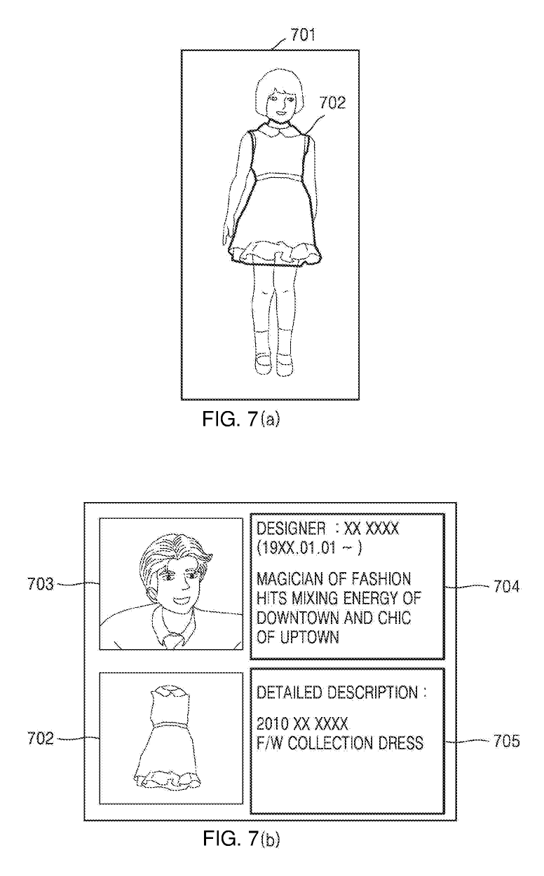

Alternatively, as shown in FIGS. 7(a) and 7(b), when the user assigned an area 701 as a search area from among the entire screen, a feature point of an object 702 included in the search area 701 may be extracted as a parameter. Also, search information 703 through 705 of the object 702 may be provided by using the parameter. The search query generator 224 may generate a search query including the at least one object and the parameter. When one or more search areas assigned by the user is a first search area and a second search area, one search query including all of one or more objects detected from the first and second search areas and parameters that are features of the one or more objects may be generated. The search query generator 224 may generate a first search query including a first object from among the detected one or more objects and a first parameter that is a feature of the first object, and generate a second search query including a second object different from the first object from among the detected one or more objects and a second parameter that is a feature of the second object. The at least one object and the at least one parameter may be included in the search query based on AND or OR conditions.

The search query transmitter 225 may transmit at least one search query to a server. Here, the search query transmitter 225 may communicate with an external device through the communication unit 210.

The search result receiver 226 may receive all of search results corresponding to the at least one search query from the service server. Here, the search result corresponding to the search query may vary according to the object included in the search query.

For example, as shown in FIGS. 5(a) and 5(b), when the object 502 is a person, related information of the person, such as a name, may be found and provided, and as shown in FIGS. 6(a) and 6(b), when the objects 602 and 603 are animals, information of the animals, such as scientific names, kingdoms, phyla, classes, families, and sounds, may be found and provided. Also, as shown in FIGS. 7(a) and 7(b), when the object 702 is a garment, the garment may be searched for, and image information 703 and text information 704 of a designer of the garment, and text information 705 of the garment may be provided.

The search service providing apparatus 200 according to an embodiment of the present disclosure may provide a search result of a search word input not only through text, but also through any one of various input methods, such as an image, a video, and voice, and in particular, may provide a search result based on data input through at least two input methods. Also, the search service providing apparatus 200 according to an embodiment of the present disclosure may provide a search result by determining details the user wants to know according to a type of an object after specifying the object included in search data, even when the user does not specifically specify the object to be searched for.

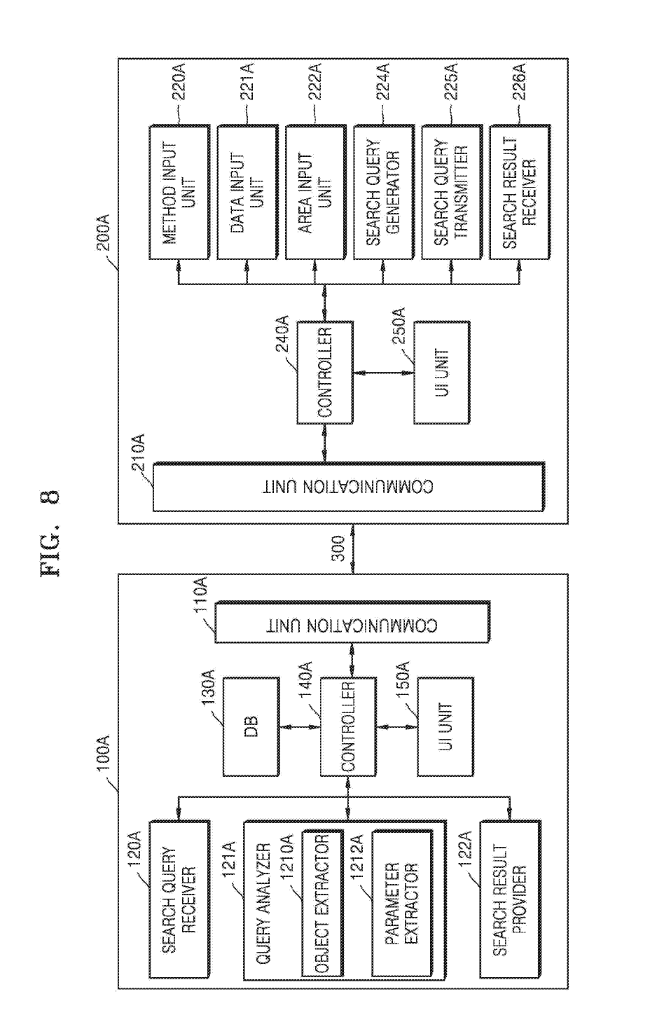

FIG. 8 is a diagram of a search service providing system according to another embodiment of the present disclosure.

Referring to FIG. 8, the search service providing system according to the other embodiment of the present disclosure may include a service server 100A and a search service providing apparatus 200A, and the service server 100A according to the current embodiment may include a communication unit 110A, a search query receiver 120A, a query analyzer 121A, and a search result provider 122A. Also, the search service providing apparatus 200A according to the current embodiment may include a method input unit 220A, a data input unit 221A, an area input unit 222A, a search query generator 224A, a search query transmitter 225A, and a search result receiver 226A.

Here, the method input unit 220A, the data input unit 221A, and the area input unit 222A of the search service providing apparatus 200A are respectively the same as the input data type display unit 220, the search target data input controller 221, and the search area input unit 222 of FIG. 2, details thereof are not repeated again.

The search query generator 224A of the search service providing apparatus 200A generates a search query including a search area. The search query may be transmitted to the service server 100A through the search query transmitter 225A.

The search query receiver 120A of the service server 100A may receive a search query including at least one piece of data from a terminal. Here, the at least one piece of data may be one or more types of any one of text, an image, a video, and voice.

The query analyzer 121A may analyze data included in a search query by using a method according to a type of the data. The query analyzer 121A may detect an object included in the data, and extract a parameter that is a feature of the object.

The search result provider 122A may transmit a search result corresponding to the object and the parameter included in the search query, to a user terminal. As described with reference to FIG. 2, the search result may vary according to a type of the object included in the search query.

Here, the query analyzer 121A may include an object extractor 1210A and a parameter extractor 1212A.

The object extractor 1210A may extract one or more objects included in input data. The object extractor 1210A may extract one or more objects included in a search area from input data. Examples of a method of detecting an object from an image or video file includes a color-based method, an area-based method, an active contour-based method, a feature-based method, but are not limited thereto. Since such methods are well known, details thereof are not provided herein.

The parameter extractor 1212A may extract a feature of an object as a parameter. The parameter extractor 1212A may extract a feature point included in an object as a parameter. Here, the feature point is a point for easily identifying an object even when a shape, size, or location of the object is changed, and is a point easily found from an image even when a point of view or illumination of a camera is changed. Generally, a feature point that satisfactorily shows a feature of an object is a corner point, and such a corner point may be extracted through a well-known algorithm for extracting a feature point. Since the corner point is well-known technology, details thereof are not provided herein.

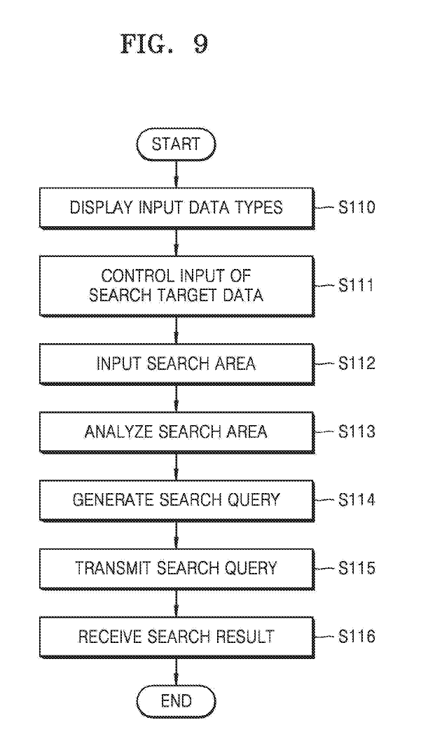

FIG. 9 is a flowchart of a search service providing method according to an embodiment of the present disclosure.

Referring to FIG. 9, the search service providing method according to an embodiment of the present disclosure may include displaying an input data type (operation S110), controlling an input of search target data (operation S111), receiving a search area (operation S112), analyzing the search area (operation S113), generating a search query (operation S114), transmitting the search query (operation S115), and receiving a search result (operation S116).

In operation S110, a plurality of selectable input data types are displayed such that a user may select a plurality of input data types. For example, in operation S110, at least two input data types from among text, an image, voice, and a video are displayed on the apparatus such that the user may select at least two of the at least two input data types.

In other words, as shown in FIG. 4 (a), the user may select the text T and the image I from among the text T, the image I, the voice V, and the video M displayed on the search service providing apparatus 200. Here, a method of selecting a plurality of input data types may be performed via touch-and-drag as shown in FIG. 4 (a), or may be performed via any one of various manners, such as long tap-and-touch, and simultaneous touch.

In operation S111, the apparatus may control data to be received according to at least one input method received in operation S110. In other words, when a plurality of input methods received from the user are a first input method and a second input method, in operation S111, first data according to the first input method and second data according to the second input method may each be received.

In operation S111, the apparatus may receive at least one piece of data according to a type of the selected input data type, and at this time, an input method may vary and a screen layout shown to the user may also vary. When an input method is text, a keyboard screen for inputting text may be displayed, and when an input method is an image or a video, a real-time image through an imaging unit (not shown) may be displayed or a stored image or video list may be displayed. When an input method is voice, a screen for receiving sound data through a sound input unit (not shown) may be displayed or a stored voice file list may be displayed.

Here, in operation S111, the apparatus may receive search target data corresponding to each of the plurality of input data types. For example, when the user selects two or more input data types from among a plurality of input data types as shown in FIG. 4 (a), the apparatus may receive, as image data, an image captured through the imaging unit and at the same time, receive text data through a text input window displayed together on the image, with respect to the image and the text that are the selected input data types as shown in FIG. 4 (b), in operation S111. In other words, as shown in FIG. 4B, the image captured through the imaging unit and the text of “how much?” input through the text input unit are each input as the search target data. Also, a search is performed on the search target data, and a search result may be provided as shown in FIG. 4 (c).

When an input method received from the user is a first input method and/or a second input method, in operation S111, the apparatus may sequentially receive first input data according to the first input method and second input data according to the second input method.

In operation S112, the apparatus may control a search area including an object to be searched for to be received from the user within data. When two pieces of data, i.e., the first input data and the second input data, are received from the user, some or all of the first input data may be received as a first search area and some or all of the second input data may be received as a second search area, from the user. A method of receiving a search region from the user in operation S112 may vary according to a type of input data, and at least one search area may be assigned within the first input data.

For example, as shown in FIG. 4 (b), when a type of input data is an image, a search area may be assigned by touching a certain area on the image while the image is displayed. Alternatively, when a type of input data is voice or a video, a search area may be assigned by selecting a start point and an end point of the search area from a voice file or a video file.

In operation S113, the apparatus may analyze the search area via a method classified according to a type of the data to detect at least one object included in the search area and extract at least one feature of the at least one object as a parameter. Since analyzing of the search area are same as operations of the search area analyzer, details thereof are not provided again.

In operation S114, a search query including the extracted object and parameter may be generated.

In operation S115, at least one search query may be transmitted to a service server.

In operation S116, a search result corresponding to the at least one search query may be received from the service server. Here, the search result corresponding to the search query may vary according to the object included in the search query. Since receiving of the search result according to the object is the same as operations of the search result receiver, details thereof are not provided again.

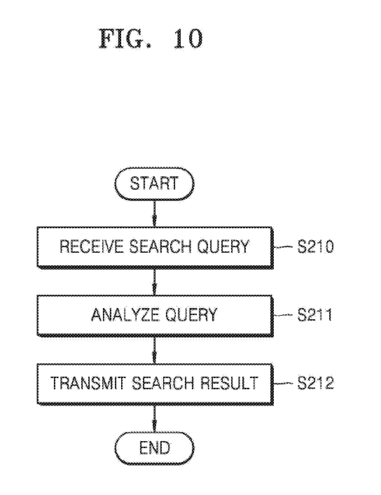

FIG. 10 is a flowchart of operations of the service server 100A according to another embodiment of the present disclosure.

Referring to FIG. 10 the operations of the service server 100 according to another embodiment of the present disclosure may include receiving a search query (operation S210), analyzing the query (operation S211), and transmitting a search result (operation S212).

In operation S210, the apparatus may receive a search query including at least one piece of data from a terminal. Here, the at least one piece of data may be one or more types from among text, an image, a video, and voice.

In operation S211, the apparatus may analyze data included in the search query by using a method according to a type of the data. In operation S211, an object included in the data may be detected and a parameter that is a feature of the object may be extracted.

In operation S212, the apparatus may transmit a search result corresponding to the object and parameter included in the search query to the user terminal.

One or more of the above embodiments may be embodied in the form of a computer program that can be run in a computer through various elements. The computer program may be recorded on a non-transitory computer-readable recording medium. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands/computer readable instructions using memory (e.g., ROMs, RAMs, and flash memories) and at least one processor, etc. Furthermore, the computer program may be transmitted and distributed in a network, e.g., as software or an application.

The computer program may be designed and configured specially for the disclosure by those of ordinary skill in the field of computer software. Examples of the computer program include not only machine language codes prepared by a compiler but also high-level codes executable by a computer by using an interpreter.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical”.

The use of the terms “a” and “an” and “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the present disclosure.

The units and/or modules described herein may be implemented using hardware components or a combination of hardware components and software components. For example, the hardware components may include microcontrollers, memory modules, sensors, processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The present disclosure may be applied to a search service providing apparatus, system, method, and a non-transitory computer readable medium storing a computer program.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

1. A search service providing apparatus comprising:
a memory having computer readable instructions stored thereon; and
at least one processor configured to execute the computer readable instructions to,
display a plurality of selectable input data types on a display device;
receive search target data corresponding to at least one selected data type of the plurality of input data types;
receive a search area including at least one object to be searched for within the search target data;
detect the at least one object included in the search area by analyzing the search area;
extract at least one feature of the at least one object as a parameter;
generate a search query including the extracted at least one object and the parameter; and
transmit the search query to a service server.

2. The search service providing apparatus of claim 1, wherein the at least one processor is further configured to receive a search result corresponding to the search query from the service server.

3. The search service providing apparatus of claim 1, wherein the at least one processor is further configured to:
receive a real-time image input through an imaging device as the search target data, or receive at least one image file as the search target data when the selected data type is an image; and
receive sound data input through a sound input device as the search target data, or receive at least one voice file as the search target data when the selected data type is voice.

4. The search service providing apparatus of claim 1, wherein the at least one processor is further configured to:
convert the search target data to text when the search target data included in the search area is voice data; and
extract the text as the parameter.

5. The search service providing apparatus of claim 2, wherein the at least one processor is further configured to, when the object to be searched for is a person, receive information about the person including the parameter as the search result.

6. The search service providing apparatus of claim 2, wherein the at least one processor is further configured to, when the object to be searched for is a garment, receive information about a manufacturer who made the object, or information about the object including the parameter as the search result.

7. A service server comprising:
a memory having computer readable instructions stored thereon; and
at least one processor configured to execute the computer readable instructions to,
receive a search query including at least one piece of data from a search service providing apparatus,
detect at least one object included in the at least one piece of data,
extract a feature of the at least one object as a parameter, and
transmit a search result matching the at least one object and the parameter to the search service providing apparatus.

8. The service server of claim 7, wherein the at least one processor is further configured to:
when the at least one piece of data included in the search query is an image type or a video type,
detect the at least one object included in the at least one piece of data by analyzing the at least one piece of data; and
extract the feature of the at least one object as the parameter.

9. The service server of claim 7, wherein the at least one processor is further configured to:
when the at least one piece of data included in the search query is a voice type,
convert the at least one piece of data to text; and
extract the text as the parameter.

10. The service server of claim 8, wherein the at least one processor is further configured to:
when the at least one object included in the at least one piece of data is a person,
search for information about the person included in the parameter; and
transmit results of the search to the search service providing apparatus.

11. The service server of claim 8, wherein the at least one processor is further configured to:
when the at least one object included in the at least one piece of data is a garment,
search for information about a manufacturer of the garment including the parameter, or information about the garment including the parameter; and
transmit results of the search to the search service providing apparatus.

12. A search service providing system comprising:
a search service providing apparatus; and
a service server, wherein
the search service providing apparatus includes,
a first memory having first computer readable instructions stored thereon; and
at least one first processor configured to execute the first computer readable instructions to,
display a plurality of selectable input data types on a display device,
receive search target data corresponding to at least one selected data type of the plurality of input data types,
receive a search area including at least one object to be searched for within the search target data,
detect the at least one object included in the search area by analyzing the search area,
extract at least one feature of the at least one object as a parameter,
generate a search query including the at least one object and the parameter; and
transmit the search query to the service server; and
the service server includes,
a second memory having second computer readable instructions stored thereon; and
at least one second processor configured to execute the second computer readable instructions to,
receive the search query including at least one piece of data from the search service providing apparatus;
detect the at least one object included in the at least one piece of data,
extract the feature of the at least one object as the parameter; and
transmit a search result matching the at least one object and the parameter to the search service providing apparatus.

13. A search service providing method comprising:
displaying, using at least one processor, a plurality of selectable input data types on a display device;
receiving, using the at least one processor, search target data corresponding to at least one selected data type of the plurality of input data types;
receiving, using the at least one processor, a search area including at least one object to be searched for within the search target data;
detecting, using the at least one processor, the at least one object included in the search area by analyzing the search area,
extracting, using the at least one processor, at least one feature of the at least one object as a parameter;
generating, using the at least one processor, a search query including the at least one object and the parameter; and
transmitting using the at least one processor, the search query to the service server.

14. The search service providing method of claim 13, further comprising:
receiving, using the at least one processor, a search result corresponding to the search query from the service server.

15. The search service providing method of claim 13, wherein the receiving the search target data comprises:
when the selected input data type is an image, receiving a real-time image input through an imaging device as the search target data, or receiving at least one image file as the search target data, and
when the selected input data type is voice, receiving sound data input through a sound input device as the search target data, or receiving at least one voice file as the search target data.

16. The search service providing method of claim 13, wherein the converting and analyzing comprises:
when data included in the search area is voice data,
converting the data to text, and
extracting the text as the parameter.

17. The search service providing method of claim 14, wherein the receiving of the search result comprises:
when the object to be searched for is a person, receiving information about the person included in the parameter as the search result.

18. The search service providing method of claim 14, wherein the receiving of the search result comprises:
when the object to be searched for is a garment, receiving information about a manufacturer who made the object, or information about the object included in the parameter, as the search result.

19. A non-transitory computer readable medium storing computer readable instructions, which when executed by at least one processor, causes the at least one processor to execute the method of claim 13.
